(19) United States
(12) Patent Application Publication
(10) Pub. No.: US 2011/0049339 A1
(43) Pub. Date: Mar. 3, 2011

(54) CONTACT AND NON-CONTACT ENTRAPMENT PROTECTION SYSTEM

(76) Inventor: Christian LEESER, Princeton, NJ (US)

(21) Appl. No.: 12/868,020

(22) Filed: Aug. 25, 2010

Related U.S. Application Data
(60) Provisional application No. 61/238,815, filed on Sep. 1, 2009.

(51) Int. Cl. H01J 40/14

(52) U.S. Cl. 250/221

(57) ABSTRACT

The present invention relates to external entrapment protection system that allows use of the same set of photoelectric transmitter/receiver units for both sensor types of a contact type sensor and a non-contact type sensor. A kit includes the entrapment system and an elastic profile and/or a photoelectric wall mounting unit.

### CROSS REFERENCE TO RELATED APPLICATION

This application claims the benefit of U.S. Provisional Patent Application No. 61/238,815, filed Sep. 1, 2009, the entirety of which is hereby incorporated by reference into this application.

### BACKGROUND OF THE INVENTION

1. Field of the Invention

The present relates to a contact and non-contact entrapment protection system and in particular to an optical sensor which can be used in either the contact or non-contact protection system.

2. Description of the Related Art

Contact type sensor entrapment systems are known. U.S. Pat. No. 6,897,630 describes a system for sensing forces on a movable barrier including a motor and a movable barrier. A potentiometer coupled to the door determines its position. A force detection mechanism is coupled to determine a first component force value applied by the motor. An entrapment system can use the first component force value generated by the motor which is scaled using a second component force value derived from an angular position of the a trolley arm connected to the movable barrier.

U.S. Pat. No. 7,616,895 describes an optical safety edge with status and failure recognition. The optoelectronic safety sensitive edge for the safeguarded, motor-driven movement of a gate having a closing edge, operates with light from a light-transmitting device which is emitted dynamically and passed through a medium, such as air, to a light receiver device. In response to the light received, a dynamic, electrical coupling signal is generated, which is passed over an electric coupling lead back to the light-emitting device. The electric coupling signal is scanned and a release signal is generated in response to, that is, dependent on the electrical coupling signal detected. Bit-coded information concerning at least one operating parameter, such as the adjusting parameter of the light-transmitting device, is passed over the electric coupling lead. The light-transmitting device is comprised of the light transmitter and a transmitter control system.

Non-contact type sensor entrapment systems are known. U.S. Pat. No. 7,228,883 describes a photo-electric eye safety system used in conjunction with a motorized barrier operator system having a primary photo-electric eye safety device, which includes a primary emitter mounted at one side of an opening enclosed by the barrier, and a primary receiver mounted on another side of the opening and aligned to receive a beam from said primary emitter, wherein a controller monitors the primary emitter and the primary receiver, and initiates corrective action if the beam is interrupted. A supplemental photo-electric eye safety system is used comprising a supplemental emitter including supplemental emitter terminals connectable to the controller and the primary receiver, and a supplemental receiver including supplemental receiver terminals connectable to the controller and the primary receiver. The system can be used for detecting obstructions of different heights in the path of a motorized movable barrier by emitting a first beam across the movable barrier's path, receiving the first beam, triggering emission of a second beam across the movable barrier's path at a height different than the first beam, receiving the second beam and initiating at least stoppage of the movable barrier if one of the beams is interrupted.

According to the UL Standard for Safety for Door, Drapery, Gate, Louver, and Window Operators and Systems, UL 325, paragraph 30.1.1, any automatically operated commercial/industrial door operator has to be connected to an external entrapment protection device. In paragraph 30.2.1, the standard states that an external entrapment protection device provided with, or as an accessory to, a commercial/industrial operator (or system) shall consist either of a contact type sensor or a non-contact type sensor. Once this standard goes into effect on Aug. 29, 2010, operator and door manufacturers, as well as door installers, will have to ensure that every automatically operated commercial/industrial door is equipped with one of those types of sensors. As both of those types of sensors have advantages in different types of door installations, the decisions for the type of sensor creates a logistical challenge. The information of the type of door installation lies with the door installer, whereas the decision of which types of sensor will get shipped with the operator system, lies with the operator manufacturer.

It is desirable to provide an external entrapment protection system that allows the use of the same set of photoelectric transmitter/receiver units for both a contact type sensor and a non-contact type sensor.

### SUMMARY OF THE INVENTION

The present invention relates to external entrapment protection system that allows use of the same set of photoelectric transmitter/receiver units for both sensor types of a contact type sensor and a non-contact type sensor. This allows the operator/manufacturer to ship the same transmitter/receiver units with every automatic operator and the installer can then decide to either install them as a contact or as a non-contact sensor. This provides a great logistical advantage for the operator manufacturers as they only have to deal with one expensive transmitter/receiver unit and do not have to have information about they type of door installation when they ship an automatic operator unit. The door installer can independently source and warehouse the inexpensive elastic profiles and photoelectric wall fixture units.

The invention will be more fully described by reference to the following drawings.

### BRIEF DESCRIPTION OF THE DRAWINGS

FIG. 1 is a schematic diagram of an entrapment protection system in a contact sensor type embodiment.

FIG. 2 is a schematic diagram of the entrapment protection system in a non-contact sensor type embodiment.

FIG. 3 shows a safety sensitive edge with reference to a safeguarding closing edge in an exploded representation;

FIG. 4 shows a diagrammatic sketch of an inventive safety sensitive edge in a first operating state;

FIG. 5 shows the inventive safety sensitive edge of FIG. 4 in a second operating state.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

Entrapment protection system 10 provides a non-contact type sensor to create a non-contact sensor application and a contact type sensor to create a contact sensor application. For example, the contact type sensor and the non-contact type sensor can include through-beam photoelectric sensors including a transmitter transmitting light and a receiver receiving it both in separate units or reflective photoelectric sensors including a combined transmitter/receiver unit in which the transmitter transmits light onto a unit with a reflective surface and the receiver receives the reflected light. In one embodiment, a reflective system can be used as a contact or non-contact sensor is described in U.S. Pat. No. 5,790,259, hereby incorporated by reference. Non-contact sensors and contact sensors can include a communication interface for communicating signaling information. The communication interface can include, for example, a dynamic output signal, transistor output signal or relay output signal.

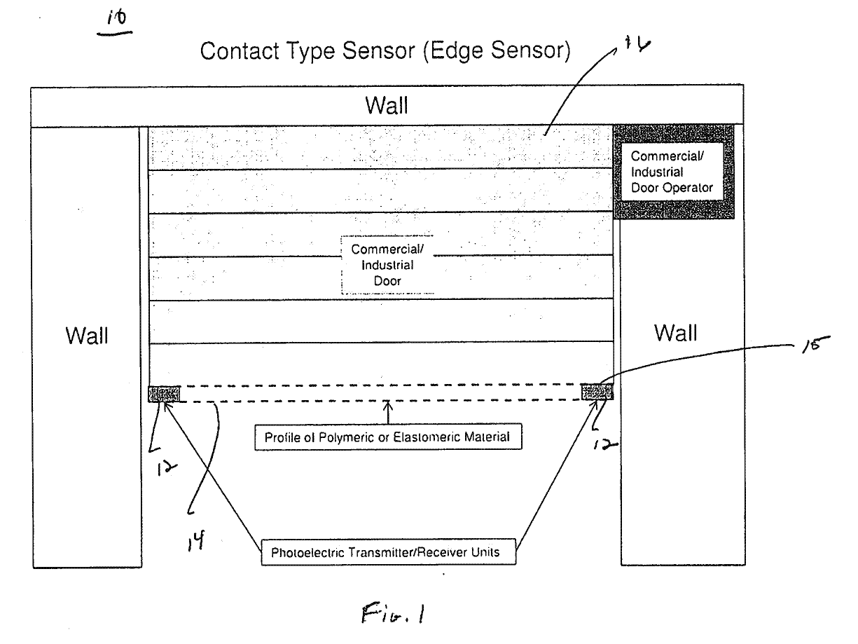

In the contact type sensor application, transmitter/receiver units 12 are inserted into elastic circular profile 14. Elastic circular profile 14 can be connected to bottom edge 15 of moving part of the door 16, as shown in FIG. 1. For example, bottom edge 15 can be formed of polymeric or elastomeric material. The contact sensor formed by transmitter/receiver units 12 gets activated by “contacting” the elastic material of elastic circular profile 14 which then interrupts the flow of light inside the circular profile.

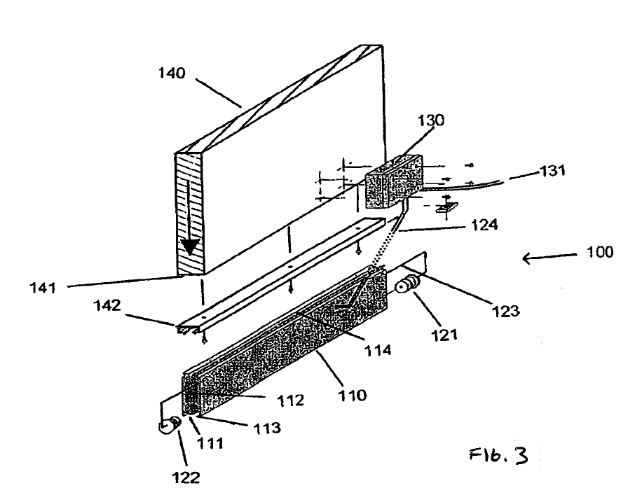

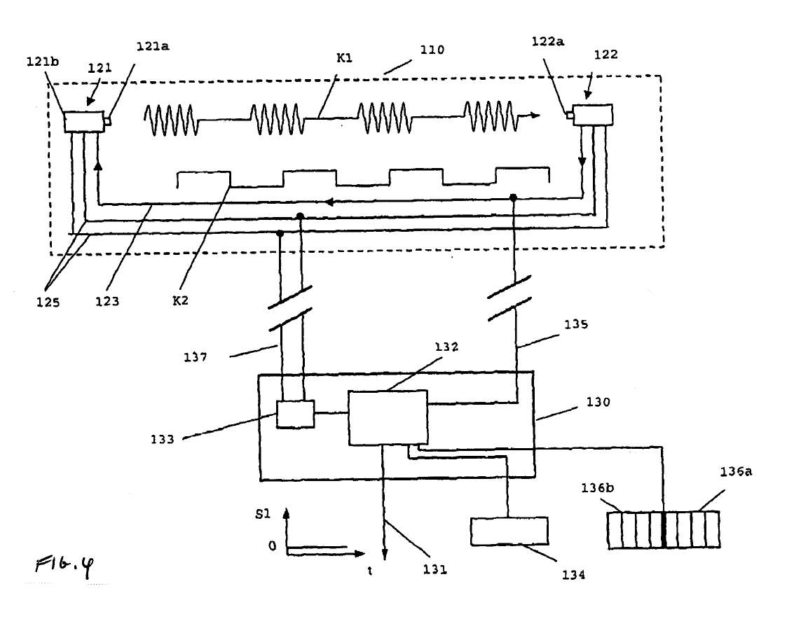

In one embodiment, transmitter/receiver units 12 can be optical devices. U.S. patent application Ser. No. 11/371,836, hereby incorporated by reference into this application, provides a description of contact sensor operation principles and as shown in FIGS. 3 and 4. Safety sensitive edge 100, which is to be fastened to a roller shutter, of which a shutter segment 140 is shown in FIG. 3. Sensitive edge 100 comprises, as essential components, an optical transmitter device 121 and an optical receiver device 122, which are coupled over an electric coupling lead 123 and the light path between the transmitter device and the receiver device, so that a feed-back loop is created. In a manner not shown, lead 124 connects electrical coupling lead 123 with evaluating device 130. In the example shown, safety sensitive edge 100 detects the deformation of a hollow rubber profile 110, which is constructed rectangularly and has a so-called switch chamber 111 as well as a tracking chamber 112, both of which extend at a distance from one another along a hollow profile. In the embodiment shown, the switching chamber 111 is constructed in the shape of a hollow cylinder, the optical transmitter device 121 being introduced at a first end and the assigned optical receiver device at the other end of the profile. The periphery of the transmitter device as well as that of the receiver device is fitted to the periphery of the switching chamber, so that these can simply be inserted. The transmitter device 121 comprises a light transmitter 121a in the form of an LED and an assigned transmitter control 121b, which triggers the light transmitter to emit light. In an appropriate manner, the receiver device 122 comprises an optical receiver 122a in the form of a photodiode, which is matched to the light emitted by the light transmitter 121a. Accordingly, the components given form an optoelectronic sensitive edge, at which the light, emitted by the light transmitter 121a, is taken up by the receiver 122a, converted into electrical pulses assigned to the optical pulses and transmitted over the electric coupling lead 123 back to the light transmitter. The components named accordingly form a feedback system.

On the longitudinal side, which faces the closing edge 141 of the gate, the hollow rubber profile 110 has two link plates 114, which enable lateral insertion in a C profile 142. The C profile 142 itself is fastened to the closing edge 141 of the gate by means of screws.

As already stated, the dynamic electric coupling signal from the electric coupling lead 123 is tapped by the lead 124 and taken to the evaluating device 130, which works as a central control device. The electric coupling signal is evaluated there and, in response thereto, that is, depending on the coupling signal detected, an output signal S1 of the optoelectronic safety sensitive edge 100, which is put out over the output signal lead 131 and is referred to as the release signal, is generated. This output signal of the sensitive edge is taken in a manner not shown to a control system for the gate driving mechanism, which evaluates the signal, for example, in order to move the gate further in the closing direction as requested by the release signal, or to stop or reverse the gate, when the actuation of the safety sensitive edge is detected. This operating state occurs, if, during the movement of the closing edge 141, the latter is moved against an obstacle, as a result of which, to begin with, the hollow profile 110 comes up against the obstacle and is deformed.

Reference is made to FIG. 4, which represents a diagrammatic sketch of the sensitive edge, for describing the mode of functioning of the inventive safety sensitive edge. The safety sensitive edge comprises the sensor system, consisting of the hollow profile 110 and the coupled transmitter and receiver devices 121, 122. The evaluating device 130 is connected with the sensor system over the electrical tapping lead 135, which is connected to the electrical coupling lead 123. For supplying the sensor system with energy, the evaluating device 130 has a controllable voltage source 133, with which the transmitter device 121 and the receiver device 122 are connected over the supply leads 137. In this respect, the lead connection 124 in FIG. 3 of corresponds to the tapping lead, 135, and the supply leads 137, shown in FIG. 4.

Optical transmitter 121a emits dynamic light pulses, which are shown as an optical coupling signal K1. These light pulses are detected by the receiver device 122 and converted in a predetermined manner into an electrical coupling signal K2, which is fed back over the electric lead 123 to the transmitter device 121. Information as to whether the light, emitted by the transmitter device 121, has arrived at the receiver device 122, is supplied over this feedback to the optical transmitter device 121. The electrical coupling signal, detected by means of the tapping lead 135, is supplied to a processor 132 in the evaluating device 130, which represents the intelligence of the evaluating device. The processor has an A/D converter, which is not shown in the Figure, in order to convert the electrical coupling signal detected, so that the information can subsequently be processed digitally.

The electrical coupling signal K2 is processed in the processor in order to determine whether or not the safety sensitive edge is actuated, that is, whether the light path between the transmitter 121a and the receiver 122a is or is not obstructed. Depending on the result of the data processing, the evaluating device 130 emits a corresponding release signal S1, the variation of which over time is shown to the left of the signal lead, over the signal lead 131. In the operating situation shown in FIG. 4, the light pulses are received by the receiver device 122 and converted into electrical pulses, which are placed on the electrical coupling lead 123. These electrical signals, arriving at the transmitter device, are then used, in turn, for controlling the output of corresponding optical light pulses, which are detected by the receiver device 122 and processed further, as described, etc. If no obstacle is detected, the signal S1 indicates that the driving mechanism can be actuated further.

In order to achieve at least batchwise a certain adaptation of the safety sensitive edge to changed operating conditions, as caused by surrounding light or ageing phenomena of the participating components, provisions are made so that the power, with which the light transmitter 121a sends out light pulses, is adjusted automatically. This is accomplished in that the transmitter 121a sequentially emits light pulses with different intensities, and the light intensity, which is required so that the receiver 122a still recognizes these light pulses, is determined in this way. Such an automatic adaptation of the system to the circumstances is very advantageous. However, for conventional safety sensitive edges, information concerning how individual operating parameters of the system must be adjusted so that the operation can be maintained, is not available in the evaluating device.

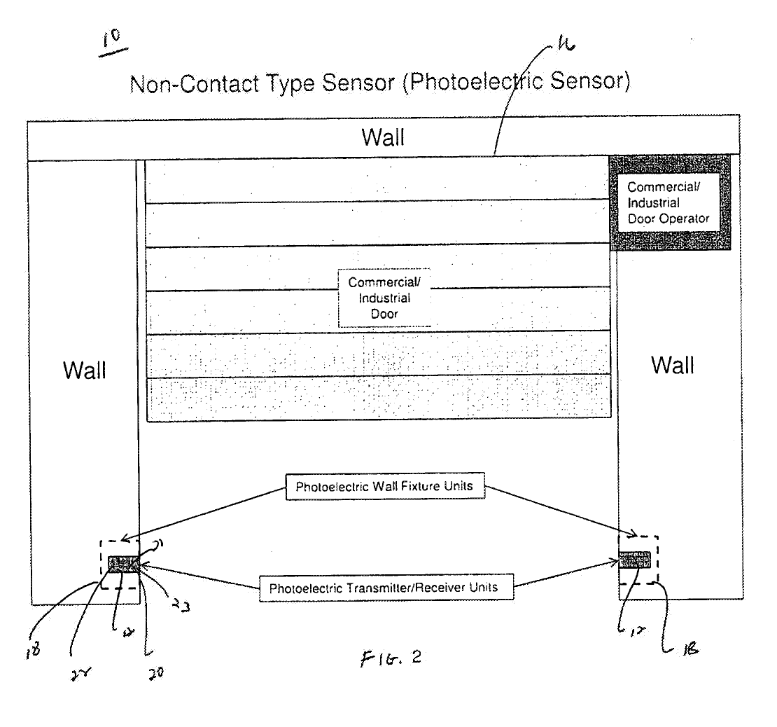

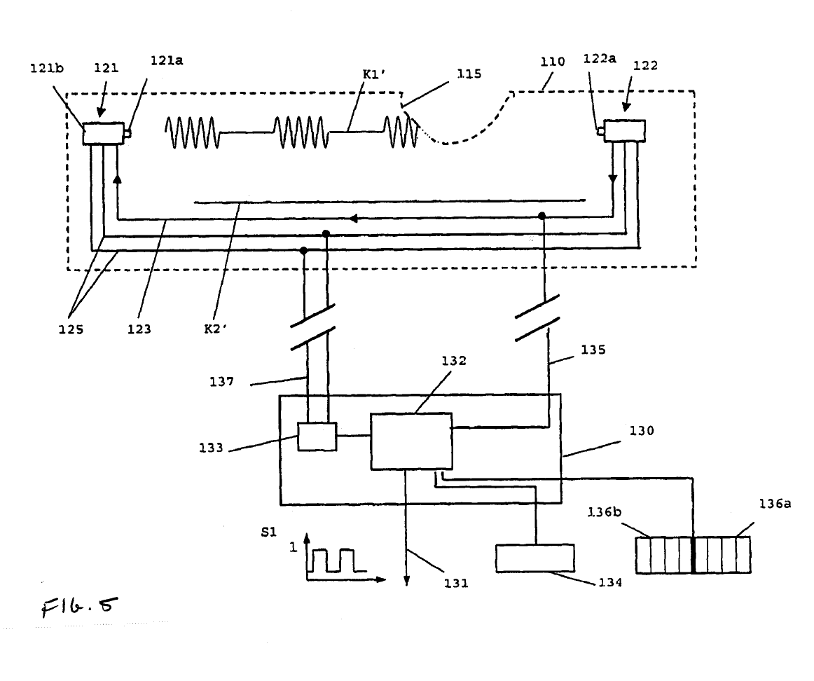

FIG. 5 shows another operating situation, which is different from that of FIG. 4. The optical path between the transmitter device 121 and the receiver device 122 is interrupted by an elastic deformation 115 of the closing profile 110 caused by an obstacle, which is not shown, so that the receiver 122a transmits an appropriate electrical coupling signal K2 to the transmitter 121 over the electrical coupling, lead 123. A comparison of the signal K2′ with the operating situation in FIG. 2 shows that the electrical coupling signals K2 and K2′ are different. This is also detected over the tapping lead 135 by the processor 132, which subsequently, in response to the electrical coupling signal detected, puts out an assigned release signal S1 to the output signal lead 131. This signal S1 differs from the output signal of the situation shown in FIG. 4 and causes the driving mechanism, which is not shown, to be stopped or reversed.

The system of the present invention fulfills the above-described monitoring requirement, as well as the edge sensor requirements described in paragraph 36 of the UL 325 standard.

To create a non-contact sensor application, transmitter/receiver units 12 are installed into the photoelectric wall mounting units 18, as shown in FIG. 2. Transmitter unit 20 emits a light beam 21 that is received by receiver unit 22. Sensor 23 is activated by interrupting light beam 21. The combination of the optical characteristics of transmitter/receiver units 12 and photoelectric wall mounting units 18 ensure that system 10 meets the sensitivity requirements of paragraph 35.3 and the ambient light test of paragraph 35.4 of the UL 325 standard.

Alternatively, transmitter/receiver units 12 are combined transmitter/receiver units in which the transmitter transmits light onto a unit with a reflective surface and the receiver receives the reflected light.

In one embodiment, a kit can include transmitter/receiver units 12, elastic circular profile 14, and/or photoelectric wall mounting units 18.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An external entrapment system comprising:
a photoelectric transmitter/receiver unit, said photoelectric transmitter/receiver unit adapted for operation with a contact type sensor and a non-contact type sensor.

2. The entrapment system of claim 1, wherein the photoelectric transmitter/receiver unit comprises a light transmitter device with a light transmitter for generating a light beam and a light receiver device being optically coupled to said light transmitter device,
wherein the contact type sensor and the non-contact type sensor is activated by interrupting the light beam.

3. The light entrapment system of claim 1 wherein the photoelectric transmitter/receiver unit further comprises:
a transmitter control system, by means of which at least one operating parameter of the light transmitter device can be adjusted;
a coupling signal; and
an evaluating device with means for detecting the optical, dynamic coupling signal, the evaluating device, generating a release signal in response to the detected, optical dynamic, coupling signal; wherein the light transmitter device sends out a signal, in which information is bit-coded, which is assigned to an adjusting parameter of the light transmitter device.

4. The entrapment system of claim 3, wherein the coupling is an optical dynamic coupling signal comprising the bit-coded information concerning at least one adjusting parameter of the light transmitter is sent out by the light transmitter device as an optical signal and the light receiver device has means for detecting the information in the optical coupling signal and for coding this information in the electric coupling signal.

5. The entrapment system of claim 4, wherein the evaluating device has decoding means for decoding information in the optical dynamic signal, which is assigned to at least one adjusting parameter of the light transmitter and/or of the light receiver.

6. The entrapment system of claim 4 wherein the optical dynamic coupling signal is within a deformable hollow elastic profile connected to a bottom edge of a moving part of a door.

7. The entrapment system of claim 1 wherein the transmitter/receiver unit is adjusted for operation with the contact type sensor and is adapted for insertion into an elastic profile.

8. The entrapment system of claim 4 wherein the elastic profile is adapted to be connected to a bottom edge of a moving door.

9. The entrapment system of claim 1 wherein the transmitter/receiver unit is adjusted for operation with the non-contact type sensor and is adapted for installation in a photoelectric wall mounting unit.

10. The entrapment system of claim 1 wherein the contact type sensor and the non-contact type sensor is a through-beam photoelectric sensor.

11. The entrapment system of claim 1 wherein the contact type sensor and the non-contact type sensor is a reflective photoelectric sensor.

12. A method for providing an external entrapment system comprising:
providing a photoelectric transmitter/receiver unit, said photoelectric transmitter/receiver unit adapted for operation with a contact type sensor and a non-contact type sensor.

13. The method of claim 12 wherein the photoelectric transmitter/receiver unit comprises a light transmitter device with a light transmitter for generating a light beam and a light receiver device being optically coupled to said light transmitter device and wherein the contact type sensor and the non-contact type sensor is activated by interrupting the light beam.

14. The method of claim 12 wherein the photoelectric transmitter/receiver unit further comprises a transmitter control system, by means of which at least one operating parameter of the light transmitter can be adjusted;
an coupling signal; and
an evaluating device with means for detecting the coupling signal, the evaluating device, generating a release signal in response to the detected, coupling signal; wherein the light transmitter device sends out a signal, in which information bit-coded, which is assigned to an adjusting parameter of the light transmitter.

15. The method of claim 12 wherein the coupling is an optical dynamic coupling signal.

16. The method of claim 12 further comprising the step of inserting into an elastic profile the transmitter/receiver unit for operation with the contact type sensor.

17. The method of claim 16 wherein the elastic profile is adapted to be connected to a bottom edge of a moving door.

18. The method of claim 12 further comprising the step of installing in a photoelectric wall mounting unit the transmitter/receiver unit for operation with the non-contact type sensor.

19. The entrapment system of claim 12 wherein the contact type sensor and the non-contact type sensor is a through-beam photoelectric sensor.

20. The entrapment system of claim 12 wherein the contact type sensor and the non-contact type sensor is a reflective photoelectric sensor.

21. A kit for entrapment system comprising:
a photoelectric transmitter/receiver unit, said photoelectric transmitter/receiver unit adapted for operation with a contact type sensor and a non-contact type sensor.

22. The kit of claim 19 wherein the entrapment system comprises an elastic profile and/or a photoelectric wall mounting unit.

23. The kit of claim 19 wherein the contact type sensor and the non-contact type sensor is a through-beam photoelectric sensor.

24. The kit of claim 19 wherein the contact type sensor and the non-contact type sensor is a reflective photoelectric sensor.
